(19) United States
(12) Patent Application Publication
(10) Pub. No.: US 2024/0396200 A1
(43) Pub. Date: Nov. 28, 2024

(54) ANTENNA TUNING AND FILTERING FOR DEEP TRANSMITTER EXTENSION SUBS

(71) Applicant: Halliburton Energy Services, Inc., Houston, TX (US)

(72) Inventors: Matthew C. Griffing, Houston, TX (US); Hsu-Hsiang Wu, Houston, TX (US)

(21) Appl. No.: 18/323,219

(22) Filed: May 24, 2023

(51) Int. Cl. H01Q 1/10; H01Q 3/12

(52) U.S. Cl. CPC H01Q 1/10; H01Q 3/12

(57) ABSTRACT

Some implementations may include a subassembly configured for attachment to a tubular in a borehole. The subassembly may include a tuning module configured to tune a first antenna to a first frequency based on a design requirement of the first antenna or a desired distance between the first antenna and a second antenna. The subassembly also may include the first antenna configured to transmit or receive a signal at the first frequency to or from the second antenna.

### TECHNICAL FIELD

The disclosure generally relates to the field of drilling tools, and more specifically to resistivity and geosteering tools with deep transmitter extension subassemblies.

### BACKGROUND

Developing drilling tools, such as resistivity and geosteering tools, with deeper transmitter-to-receiver (T-R) spacing than the current spacing in some commercial tool designs (such as T-R spacing greater than 13 ft) may require more or larger antennas in an extension modular deep transmitter subassembly (“sub”) attachable to an existing tool. This may allow more selection of T-R spacing operated at different frequencies for different formation detection ranges. The challenge is that existing designs of the deep transmitter sub may not include electronics for enabling a modular sub design and may not be attachable to any shallow antenna collars having the electronics. Hence, users may not be able to add switching networks in a transmitter sub to select preferred frequencies based on the T-R spacing. This may lead to difficulties in modifying the existing electronics hardware to accommodate the new longer T-R spacing antennas which may have significantly higher inductance that may require retuning.

### BRIEF DESCRIPTION OF THE DRAWINGS

Embodiments of the disclosure may be better understood by referencing the accompanying drawings.

FIG. 1 is a diagrammatic illustration showing an example resistivity tool and subassembly.

FIG. 2A graphical representation showing a relationship between impedance and frequency for series tuning using an inductor capacitor (LC) circuit.

FIG. 2B is a graphical representation showing a relationship between impedance and frequency for parallel tuning using an inductor capacitor (LC) circuit.

FIG. 3A is a diagrammatic illustration showing example components for series tuning one or more transmitter antennas in a deep extension sub.

FIG. 3B is a diagrammatic illustration showing example components for parallel tuning one or more transmitter antennas in a deep extension sub.

FIG. 4 is a diagrammatic illustration of an example sub including an example tuning module.

FIG. 5 is a diagrammatic illustration showing an example tuning network configured for use in a sub.

FIG. 6A is a diagrammatic illustration showing an example tuning module configured to tune a transmitter antenna via parallel tuning.

FIG. 6B is a diagrammatic illustration showing an example tuning module configured to tune a transmitter antenna via series tuning.

FIG. 7A is a diagrammatic illustration of a tuning module configured to passively tune transmitter antenna of a sub via series tuning.

FIG. 7B is a diagrammatic illustration of a tuning module configured to passively tune transmitter antenna of a sub via parallel tuning.

FIG. 8 is a diagrammatic/schematic illustration showing example tuning networks configured for use with a sub.

FIG. 9 is a graph showing tuning data from a simulation involving the tuning networks 802, 804, and 806.

FIG. 10 is a diagrammatic/schematic illustration showing example tuning networks configured for use with a sub.

FIG. 11 is a graph showing tuning data from a simulation involving the tuning networks 1002, 1004, and 1006.

FIG. 12 is a diagrammatic/schematic illustration showing example tuning networks configured for use with a sub.

FIG. 13 is a graph showing tuning data from a simulation involving the tuning networks 1202, 1204, and 1206.

FIG. 14 is a graph showing how tuning adjustments may be used to achieve higher frequencies.

FIG. 15 is a schematic diagram of an example drilling rig system.

### DESCRIPTION OF EMBODIMENTS

The description that follows includes example systems, methods, techniques, and program flows that embody implementations of the disclosure. However, this disclosure may be practiced without these specific details. For clarity, some well-known instruction instances, protocols, structures, and techniques may not be shown in detail.

### Overview

Users of a downhole resistivity tool may want measurements deeper than the tool's capability. Achieving greater measurement depth may require complex modifications to the downhole resistivity tool. Modifying electronics hardware on the resistivity tool may present a number of difficulties. For example, modifications may necessitate disassembling and reassembling the resistivity tool, which may take considerable time and risk damage. Also, modifying electronics hardware in the tool may create additional costs of labor and new electronics and/or modification of the existing electronics. Also, field locations may not be able to perform such modifications, so the resistivity tool may require shipping to specialized locations that can perform the work, thereby incurring additional shipping costs. Additionally, modifying the tuning in the electronics may not allow them to be usable with the existing deep transmitter subassemblies, making them less modular and decreasing operating efficiency.

Some implementations increase transmitter-to-receiver (T-R) antenna spacing on a downhole tool (such as a resistivity tool) to facilitate deep measurement at lower operating frequencies without having to modify existing electronics in the downhole tools already deployed in the field, thereby saving costs, time, and reducing risk. For example, a subassembly (sub) may include a transmitter antenna that is 12 feet away (downhole) from a receiver antenna included on the main collar of the drill string. To make deeper measurements, a longer sub may replace the existing sub, where the longer sub creates a greater distance between the transmitter and receiver antennas (such as 15 feet between the transmitter and receiver antennas). When increasing the T-R spacing, to compensate for the signal loss due to greater distance, the antennas on the longer deep sub could be made larger by some combination of more turns, larger ferrites, and/or larger slots on the metal shields (or sleeves) that protect them from the formation while drilling. This would result in a stronger transmitted field for the receiver antennas, allowing them to be placed further apart and still maintain sufficient signal strength in all formations/situations. However, making the antennas larger will typically result in a significant increase in inductance, which could detune the system since the same operating frequencies may be used. Also, lower frequencies may be used for a longer T-R spacing, requiring retuning. Some implementations may include a tuning module that may tune transmission signals to a plurality of frequencies based on the change in the transmitter antennas to facilitate the increased distance between the transmitter and receiver antennas. In some implementations, one or more antennas are retuned to one or more frequencies based on a design requirement, such as a design requirement changing an aspect of one or more antennas. Some implementations are usable with the existing deep transmitter subs, making them more modular and increasing operating efficiency. Also, some implementations may be used to retune new deep subs with the antennas modified for higher frequencies, where these downhole tools may be suitable for very high resistivity applications (such as in certain parts of the Kingdom of Saudi Arabia).

Some implementations increase the depth of the downhole tool measurement without having to modify the existing electronics in the tools already deployed in the fleet, saving costs, time, and reducing risk. This may allow them to be usable with the existing deep transmitter subs, making them more modular and increasing operating efficiency. Also, some implementations may be used to retune new deep subs with the antennas modified for higher frequencies, to be used in very high resistivity applications (such as in certain parts of the Kingdom of Saudi Arabia). Some implementations enable multi-frequency multi-spacing downhole tool measurements for multiple depth of detection (DoD) capabilities. Some implementations may eliminate a need to synchronize transmitter and receiver signals in certain downhole tools.

Some implementations may be usable with the existing deep transmitter subs to be flexible for any operating frequency. Some implementations include filters in front of each deep transmitter antenna in the deep sub, enabling multi-frequency multi-modular deep transmitter subs attachable to an existing tool. The filters may be passive filters (e.g., requiring no change of firmware at all) or active filters (e.g., requiring firmware changes) to switch the operating frequency dedicated for each deep transmitter antenna. When injecting either high or low frequency in the cable, the front-end filter of each deep transmitter antenna may pass only the desired frequency to the antenna without a switch. In addition, the filter design may help tune the impedance of each antenna for optimal efficiency.

### Some Example Implementations

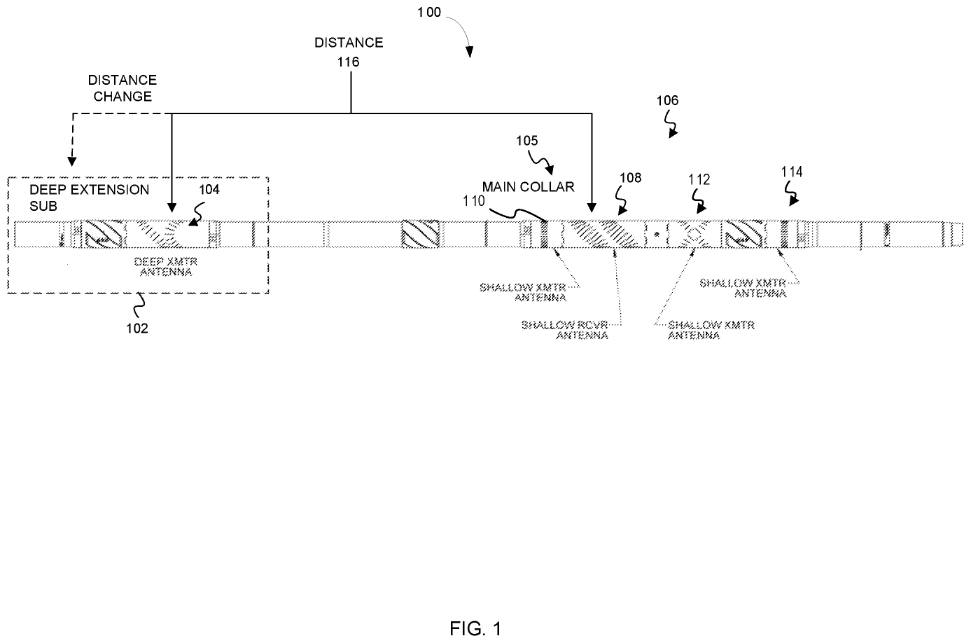

FIG. 1 is a diagrammatic illustration showing an example resistivity tool and subassembly. In FIG. 1, a drill string 100 includes a resistivity tool 106 connected to a deep extension subassembly (sub) 102. A main collar 105 of the drill string 100 may include a plurality of antennas including a shallow transmitter antenna 110, shallow receiver antennas 108, shallow transmitter antennas 112, and a shallow transmitter antenna 114. The sub 102 may include deep transmitter antennas 104.

In its initial configuration, the sub's deep transmitter antenna 104 may be separated from one of the shallow antennas (such as the shallow receiver antenna 108) by a distance 116 (such as approximately 12 feet). However, users of the resistivity tool 106 may want to increase the measurement depth. The measurement depth may be increased by increasing the distance 116 between the sub's deep transmitter antenna 104 and one or more receiver antennas on the tool 106 (such as by increasing the distance 116 to approximately 15 feet). Some implementations change the distance 116 between transmitter and receiver antennas by replacing the sub 102 with a longer sub (not shown) on which a deep transmitter antenna is situated at a different distance from one or more shallow receiver antennas (such as the shallow receiver antenna 108) on the main collar 116 of the tool 106. Alternatively, an extension device may be interposed between the sub 102 and the tool 106 to extend the distance 116 between the transmitter and receiver antennas. In some implementations, users may decrease the distance between transmitter and receiver antennas using similar methods and components.

To configure the tool 106 for deeper measurement, deep transmitter antennas on the sub 102 may be made larger by some combination of more turns, larger ferrites, and/or larger slots on the metal shields (or sleeves) that protect them from the formation while drilling. These changes to the initial configuration would result in a stronger transmitted field for the receiver antennas on the tool 106, allowing them to be placed further apart and still maintain effective signal strength in a multitude of formations and situations. However, making the antennas larger may result in a significant increase in inductance, which may detune the system because the original operating frequencies may not change. To retune the antennas, the tuning capacitance located in the electronics may need to be reduced by the same proportion, see Equation 1 below:

$${f}_{c} = \frac{1}{2 π \sqrt{LC}} \qquad ( 1 )$$

In Equation 1, f_{c}=Tuned Frequency, L=Inductance of the Antenna, and C=Tuning Capacitance in the Electronics.

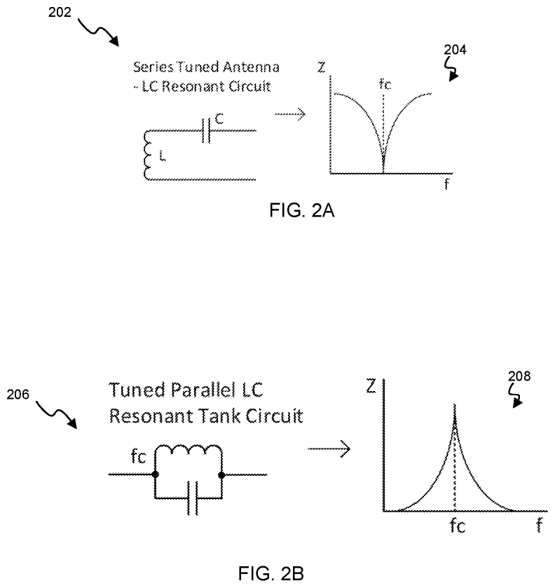

FIG. 2A is graphical illustration showing a relationship between impedance and frequency for series tuning using an inductor capacitor (LC) circuit. In FIG. 2A, a graph 204 shows a relationship between impedance (Z) and frequency for a series-tuned LC circuit 202. The graph 204 includes an X-Y plane on which the X axis shows frequency increasing from left to right and the Y axis shows impedance increasing upward. In the graph 204 (for series tuning), a transmitter antenna may be tuned to a frequency (f_{c}) at which impedance (Z) is the lowest.

FIG. 2B is a graphical representation showing a relationship between impedance and frequency for parallel tuning using an inductor capacitor (LC) circuit. In FIG. 2B, a graph 208 shows a relationship between impedance (Z) and frequency for a parallel-tuned LC circuit 206. The graph 208 includes an X-Y plane on which the X axis shows frequency increasing from left to right and the Y axis shows impedance increasing upward. In the graph 208 (for parallel tuning), a transmitter antenna may be tuned to a frequency (f_{c}) at which impedance (Z) is the highest.

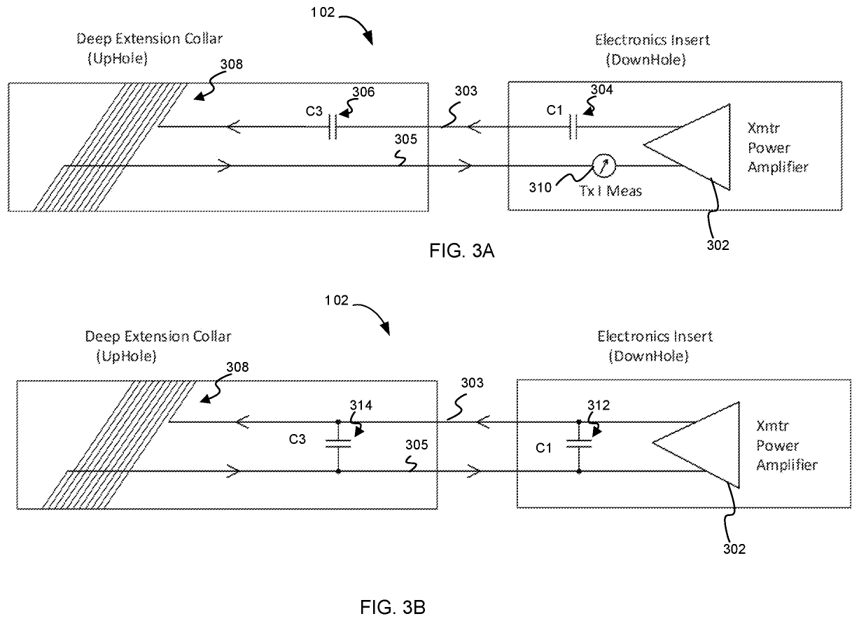

FIG. 3A is a diagrammatic illustration showing example components for series tuning one or more transmitter antennas in a deep extension sub. As shown in FIG. 3A, the sub 102 may include a transmitter power amplifier 302 connected to a tuning capacitor 304 located in the tool electronics via a conductor 303. The conductor 303 may connect the tuning capacitor 304 with an additional tuning adjustment capacitor 306 in series (capacitor 306 may be located in the deep extension sub to retune a modified antenna for example). The conductor 303 also may connect the tuning adjustment capacitor 306 with a transmitter antenna 308. The transmitter antenna 308 may be connected to a measuring device 310 via the conductor 305. The conductor 305 also may connect the measuring device 310 to the power amplifier 302.

Some implementations may reduce the effective (or equivalent) tuning capacitance without changing any of the existing electronics. As shown in FIG. 3A, one or more transmitter antennas 308 may be series-tuned to create a minimum impedance (Z) at a tuning frequency so the transmitting power amplifier 302 can drive maximum current through the transmitter antenna at the operating frequency, and to allow an accurate transmitter antenna current measurement at the electronics (such as by the transmission current measuring device 310), where the current measurements may include information used for the measurement. Because one or more transmitter antennas 308 of the sub 102 may be series-tuned, the additional adjustment capacitance 306 may be added in series to the current loop on the deep extension sub 102 to modify or reduce the effective (or equivalent) tuning capacitance by the same proportion that the antenna inductance (L) was increased. In some implementations, Equation 2 indicates a relationship between Equivalent Tuning Capacitance, Tuning Capacitance in the electronics, and Tuning Adjustment Capacitance.

$$Tuned {C}_{eq} = \frac{C 1 \times C 2}{C 1 + C 2} \qquad ( 2 )$$

In Equation 2, C_{eq}=Equivalent Tuning Capacitance, C1=Tuning Capacitance 304 in the Electronics, and C2=Tuning Adjustment Capacitance 306 added on the deep sub. This solution may be applicable for implementations in which the transmitters operate at a single frequency. Alternative implementations are described for transmitters that operate at multiple frequencies, such as where the tuning capacitors/banks are switched for the appropriate operating frequencies in the electronics (such as 3 deep frequencies including 62.5 kHz, 125 kHz, and 250 kHz).

FIG. 3B is a diagrammatic illustration showing example components for parallel tuning one or more transmitter antennas in a deep extension sub. In FIG. 3B, the transmitter power amplifier 302 may be connected to a plurality of capacitors in parallel (tuning capacitor 312 and tuning adjustment capacitor 314) via the conductors 303 and 305, where the equivalent capacitance of the parallel combination is simply the sum of the individual capacitor values. The conductor 303 also may connect the capacitors 312 (tuning capacitor located in the tool electronics) and 314 (adjustment tuning capacitor located in the deep extension sub) to one or more transmitter antennas 308. As similarly described with respect to FIG. 3A, the parallel tuning shown in FIG. 3B may be applicable for implementations in which transmitters operate in a single frequency. Alternative implementations relating to transmitters that operate at multiple frequencies are further described herein.

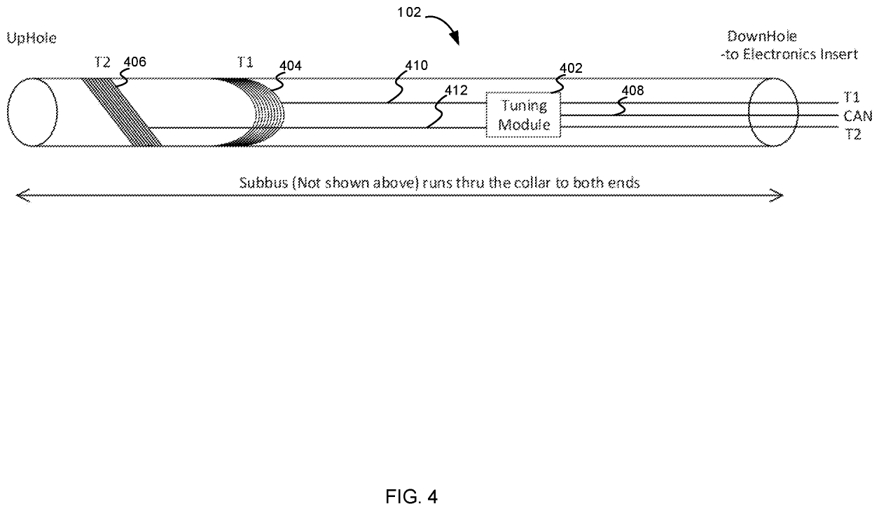

FIG. 4 is a diagrammatic illustration of an example sub including an example tuning module. In FIG. 4, the sub 102 may include a first transmitter antenna 404 and a second transmitter antenna 406. A first transmitter antenna 404 may be connected to a tuning module 402 via a conductor 410. A second transmitter antenna 406 also may be connected to the tuning module 402 via a conductor 412. The tuning module 402 may be electrically and communicatively coupled with an electronics module (not shown) via the conductor 408 and a communications bus, in this case the communication is CAN bus (Controller Area Network), however any suitable communication method/protocol could be used. The electronics module may process and/or generate signals for transmission via the transmitter antennas 404 and 406. Additionally, a Subbus (not shown), which acts as the main inter-tool communications and power bus for the BHA, may run through the sub 102.

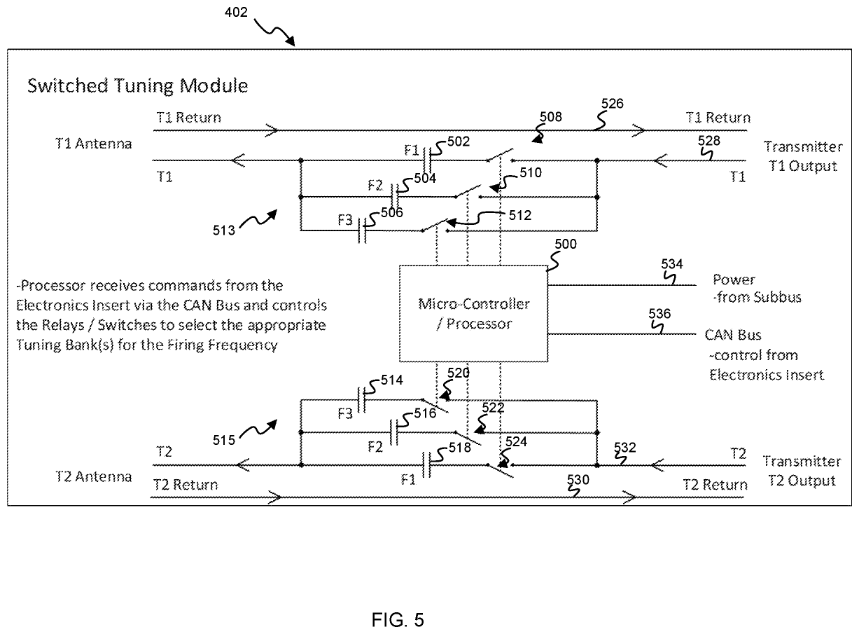

In some implementations, the tuning module 402 may utilize a configuration of capacitors and switches to tune the transmitter antennas 404 and 406 to a plurality of frequencies. In some implementations, the capacitors may be arranged for series tuning, whereas in other implementations the capacitors may be arranged for parallel tuning. FIG. 5 shows an example implementation in which the capacitors are arranged for series tuning.

FIG. 5 is a diagrammatic illustration showing an example tuning network configured for use in a sub. In FIG. 5, the tuning module 402 may include a microcontroller 500. The microcontroller 500 may be connected to a power supply 534 and a CAN bus 536, where the CAN bus 536 may be connected to the electronics insert disposed on the sub.

The microcontroller 500 may tune a first antenna (such as the transmitter antenna 404) to one of a plurality of frequencies by opening or closing any combination of the switches 508, 510, and 512. Opening or closing the switches 508, 510, and 512 may enable or disable one or more conductive signal paths through a parallel tuning network 513. For example, by closing the switch 508 while leaving switches 510 and 512 open, the microcontroller 500 may enable a first signal path that conducts a transmitter output signal to the first antenna (not shown). The transmitter output signal may be at a first frequency (such as 250 kHz or any other suitable frequency). As another example, microcontroller 500 may close the switch 510 while leaving the switches 508 and 512 open. Such a switch configuration may enable a second path through the parallel capacitor network. By enabling the second path (different from the first path), the microcontroller 500 may tune the first antenna for a transmitter output at a second frequency (different from the first frequency). The microcontroller 500 may similarly enable a third path through the capacitor 506 to tune the first antenna at a third frequency. Furthermore, microcontroller 500 may tune the first transmitter antenna to additional frequencies by simultaneously enabling two or more paths of the tuning network 513. The first transmitter antenna may be connected to a return conductor 526.

The microcontroller 500 may tune a second antenna (such as the transmitter antenna 406) to one of a plurality of frequencies by opening or closing any combination of the switches 520, 522, and 524. Opening or closing the switches 520, 522, and 524 may enable or disable one or more conductive paths through a parallel capacitor network 515. Hence, the microcontroller 500 may tune the second transmitter antenna as described with respect to the first antenna. The second transmitter antenna may be connected to a return conductor 530.

For existing tools (such as the tool 106) to operate with the switchable tuning module 402, there may be no need for any hardware changes-given that the power supply 534 and communications bus (such as CAN bus 536) may already be available. In some implementations, the tool may require updated software and/or firmware to control the tuning module 402. The tool's software and/or firmware may be updated without disassembling the tool.

Although the example implementations shown herein may include three paths, some implementations may include only one path or two or more paths. Hence, implementations may include any suitable number of signal paths by which any suitable number of antennas are tuned to any suitable number of frequencies.

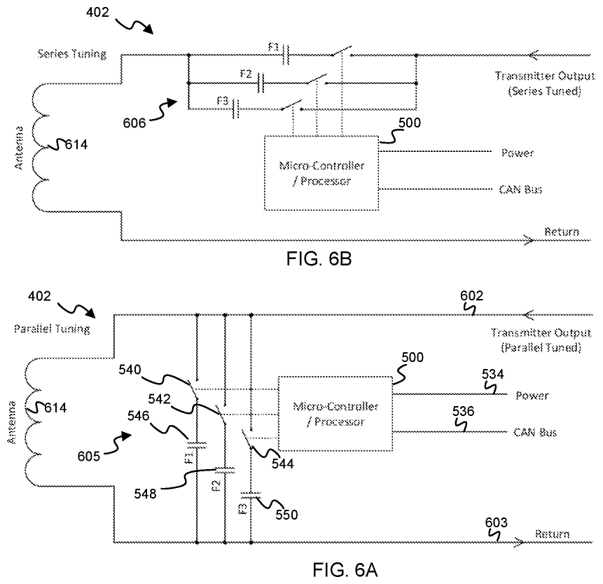

As noted, some implementations may tune one or more transmitter antennas via series tuning. FIG. 6A is a diagrammatic illustration showing an example tuning module configured to tune a transmitter antenna via parallel tuning. In FIG. 6A, the microcontroller 500 may tune the transmitter antenna 614 to one of a plurality of frequencies using parallel tuning. In FIG. 6A, the tuning module 402 may include the microcontroller 500 connected to the power supply 534 and the CAN bus 536. The microcontroller 420 may be connected to a capacitor network 605. In the capacitor network 605, capacitors 546, 548, and 550 may be connected in parallel to a transmitter output conductor 602 and a transmitter return conductor 603. The microcontroller 500 also may be connected to switches 540, 542, and 544. As similarly described with reference to FIGS. 5, the microcontroller 500 may open or close the switches 540, 542, and 544 to activate any combination of paths through the capacitor network 605 to tune the transmitter antenna 614 using parallel tuning. The tuning module 402 may be included in any suitable sub (such as sub 102) and may be adapted to tune any suitable number of transmitter antennas.

FIG. 6B is a diagrammatic illustration showing an example tuning module configured to tune a transmitter antenna via series tuning. In FIG. 6B, the microcontroller 500 may utilize a series tuning network 606 to tune the transmitter antenna 614 to one of a plurality of frequencies using series tuning. The tuning module 402 may operate as described with reference to FIG. 5. The tuning module 402 may be included in any suitable sub (such as sub 102) and may be adapted to tune any suitable number of transmitter antennas.

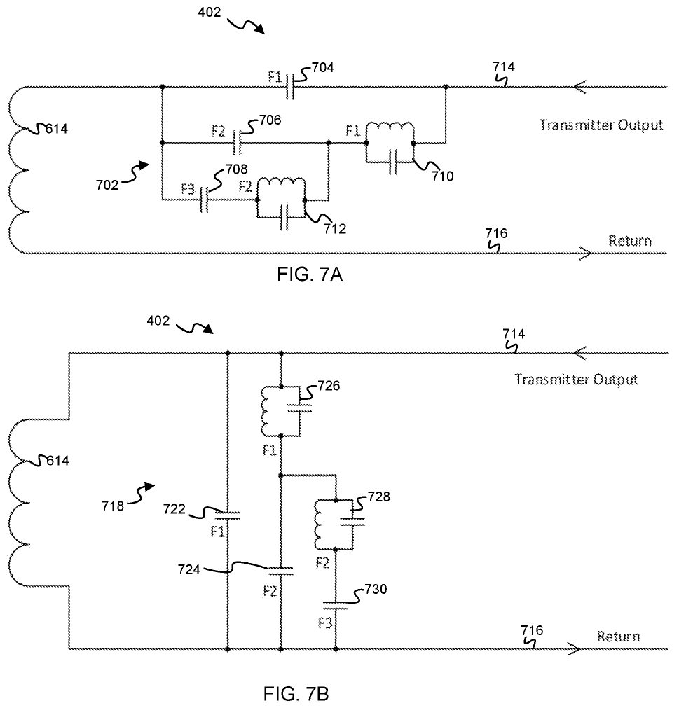

In some implementations, the tuning module 402 may passively tune one or more antennas. That is, the tuning module 402 may not need to open or close switches to activate path through a tuning network. Additionally, for passive tuning, the tool 106 need not control the tuning module 402. Instead, the tuning module 402 may automatically tunes one or more antennas for one or more frequencies. FIGS. 7A and 7B describe examples in which the tuning module 402 passively tunes transmitter antennas.

FIG. 7A is a diagrammatic illustration of a tuning module configured to passively tune transmitter antenna of a sub via series tuning. In FIG. 7A, the tuning module 402 includes a tuning network 702 that includes three signal paths to the transmitter antenna 614. In the tuning module 402, a transmitter output conductor 714 is connected to a transmitter antenna 614 which is connected to a return conductor 716. In a first path, a first capacitor 704 to tune the antenna to a first (highest) frequency, may be connected to the transmitter output conductor 714. A second path may be connected in parallel with the first path. The second path may include a first parallel inductor-capacitor (LC) circuit 710, that is tuned to reject the first frequency, connected to the transmitter output conductor 714, where the first parallel inductor-capacitor (LC) circuit 710 also may be connected in series with a second capacitor 706 to tune the antenna to a second frequency that is lower than the first. The second capacitor 706 also may be connected to the transmitter output conductor 714. A third path may be connected in parallel with the first and second paths. The third path may include a second parallel inductor-capacitor (LC) circuit 712, that is tuned to reject the second frequency, connected in series with a third capacitor 708 to tune the antenna to a third frequency that is lower than the second, which may be connected to the transmitter output conductor 714. In this manner, the antenna is simultaneously tuned to three different frequencies.

In the tuning network 702, parallel inductor-capacitor (LC) circuits are LC resonant tank circuits that may be used to present a high Impedance (Z) to the higher frequencies to prevent them from becoming detuned by the capacitor banks needed for lower frequencies. The LC resonant tank circuits may be used as band-stop or notch filters and may be tuned at a particular frequency (the higher operating frequencies) to block (or reject) the signal from the rest of the tuning network. In some instances, there may be signal strength losses at the lower frequencies due to the series resistance of the tank circuit inductors. However, the tuning network 702 may enable simultaneous tuning of all operating frequencies without any controller.

FIG. 7B is a diagrammatic illustration of a tuning module configured to passively tune transmitter antenna of a sub via parallel tuning. In FIG. 7B, the tuning module 402, the transmitter output conductor 714 may be connected to the transmitter antenna 614, which may be connected to a return conductor 716. In FIG. 7B, the tuning module 402 may include a tuning network 718, which may provide three signal paths to the transmitter antenna 614. In the tuning network, a first path may include a first capacitor 722 to tune the antenna to a first (highest) frequency, connected to the transmitter output conductor 714 and the return conductor 716. In parallel with the first path, a second path may include a first parallel inductor-capacitor (LC) circuit 726, that is tuned to reject the first frequency, connected to the transmitter output conductor 714, where the first parallel inductor-capacitor (LC) circuit 726 may also be connected in series to a second capacitor 724 to tune the antenna to a second frequency that is lower than the first, which is connected to the return conductor 716. In parallel with the first and second paths, a third path may include a second parallel inductor-capacitor (LC) circuit 728, that is tuned to reject the second frequency, connected to the first parallel inductor-capacitor (LC) circuit 726 and to a third capacitor 730 to tune the antenna to a third frequency that is lower than the second, which is connected to the return conductor 716. The tuning network 718 may passively tune the transmitter antenna 614 to a plurality of frequencies using parallel tuning.

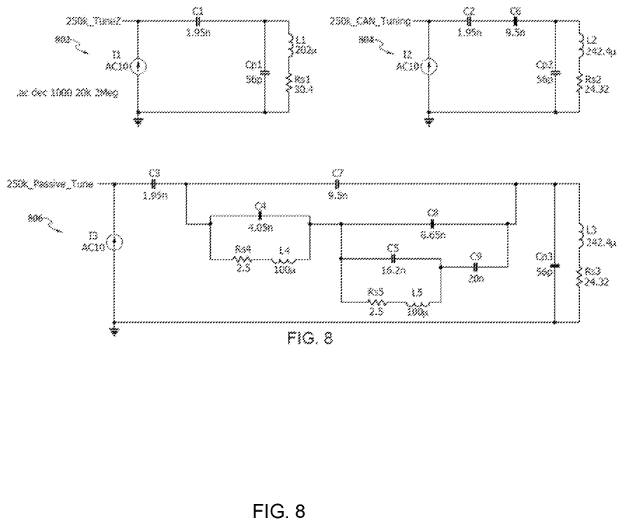

FIGS. 8-13 show additional example implementations and simulation results. The simulation results show that the implementations described herein properly adjust the tuning or otherwise retune larger deep transmitter antennas on a new deep transmitter expansion sub back to their original operating frequencies. The tuning can be properly adjusted for the higher inductance with only an adjustment tuning module on the new deep expansion sub without hardware modifications to the existing tools. This also allows them to be usable with the existing deep transmitter subs, making them more modular and increasing operating efficiency. The simulations may indicate additional resonances/peaks in the frequency response of some of the passive tuning networks due to the interactions of the LC tank circuits with the tuning network. When the additional peaks are far enough from the tuned operating frequency (or harmonic frequencies), these additional resonances/peaks in frequency do not pose any problems.

FIG. 8 is a diagrammatic/schematic illustration showing example tuning networks configured for use with a sub. In FIG. 8, a tuning network 802 may be an initial configuration that tunes a transmitter antenna on the sub 102 for a 250 kHz signal, where the transmitter antenna is separated from a receiver antenna on the tool 106 by a distance. In the tuning network 802, the antenna is represented electrically by an inductor (L1) that may have an inductance of 202 μH, a resistor (Rs1—antenna series resistance) that may have a resistance of 30.4 Ohms, and a capacitor (Cp1—antenna parasitic capacitance) that may have a capacitance of 56 pF.—A series tuning capacitor (C1—located in the tool electronics) that may have a capacitance of 1.95 nF is used to tune the antenna to the desired frequency of 250 kHz. The tuning network 802 also may include a connection to a transmitter electronics module or another AC power amplifier/source.

In FIG. 8, a tuning network 804 may be configured to retune a transmitter antenna with 20% higher inductance on the sub 102 for a 250 kHz signal, where the tuning network 804 may be controlled by a microcontroller and switches (as similarly described with reference to FIG. 5). The tuning network 804 may include a tuning capacitor (C2—located in the tool electronics) that may have a value of 1.95 nF, and a tuning adjustment capacitor (C6—located in the tuning module of the deep extension sub) that may have a value of 9.5 nF. The tuning network 804 also may include the antenna, which is represented electrically by an inductor (L2) that may have a value of 242.4 μH, a resistor (R2—antenna series resistance) that may have a value of 24.32 Ohms, and a capacitor (Cp2—antenna parasitic capacitance) that may have a value of 56 pF. The tuning network 804 also may include a connection to a transmitter electronics module or another AC power amplifier/source.

In FIG. 8, a tuning network 806 may be configured to retune a transmitter antenna with 20% higher inductance on the sub 102 for a 250 kHz signal, where the tuning network 804 may be a passive tuning network (such as the tuning network described with reference to FIGS. 7A and 7B). The tuning network may include the following components: the antenna represented electrically by a 242.4 μH inductor (L3), 24.32 ohm resistor (Rs3—antenna series resistance), and 56 pF capacitor (Cp3—antenna parasitic capacitance); 1.95 nF tuning capacitor (C3—located in the tool electronics); 9.5 nF tuning adjustment capacitor (C7—for 250 kHz tuning); 250 kHz LC tank circuit consisting of 100 μH inductor (L4), 2.5 Ohms resistor (Rs4—inductor series resistance), and 4.05 nF capacitor (C4); 8.65 nF tuning adjustment capacitor (C8—for 125 kHz tuning); 125 kHz LC tank circuit consisting of 100 μH inductor (L5), 2.5 ohm resister (Rs5—inductor series resistance), and 16.2 nF capacitor (C5); and 20 nF tuning adjustment capacitor (C9—for 62.5 kHz tuning). The tuning network 804 also may include a connection to a transmitter electronics module or another AC power amplifier/source.

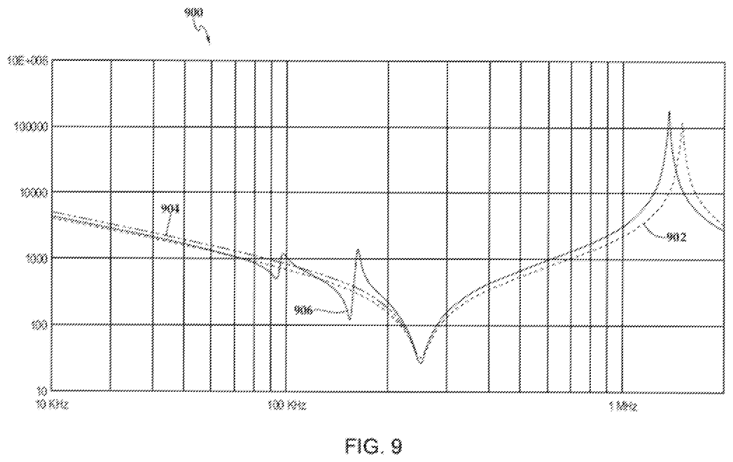

FIG. 9 is a graph showing tuning data from a simulation involving the tuning networks 802, 804, and 806. In FIG. 9, a graph 900 includes an XY plane on which an x-axis represents frequency in Hz increasing from left to right (beginning at 10 KHz and increasing logarithmically) and a y-axis represents representing signal impedance in Ohms increasing upward (beginning at 10 and increasing logarithmically). The line 902 shows a relationship between frequency and signal impedance for the tuning network 802. The line 904 shows a relationship between frequency and signal impedance for the tuning network 804. The line 906 shows a relationship between frequency and signal impedance for the tuning network 806, note the additional resonances/peaks in the frequency response due to the interactions of the LC tank circuits with the passive tuning network 806. In FIG. 9, all 3 tuning networks show a minimum impedance where the antenna is tuned at 250 KHz.

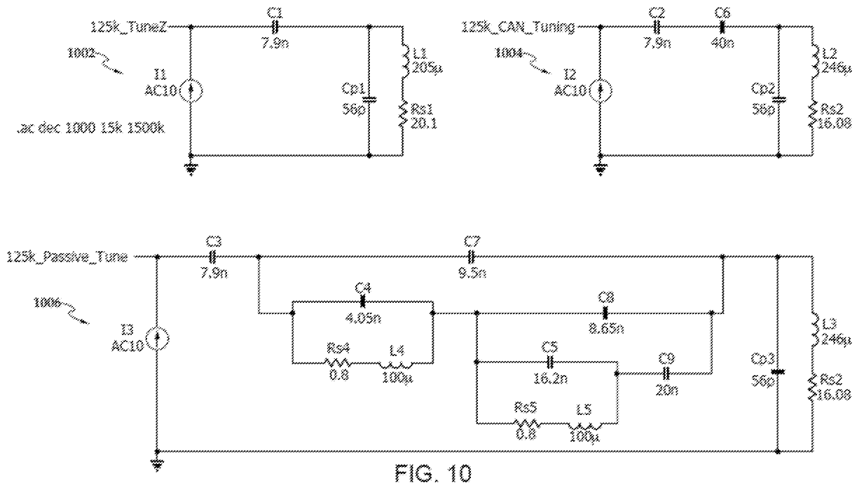

FIG. 10 is a diagrammatic/schematic illustration showing example tuning networks configured for use with a sub. In FIG. 10, a tuning network 1002 may be an initial configuration that tunes a transmitter antenna on the sub 102 for a 125 kHz signal, where the transmitter antenna is separated from a receiver antenna on the tool 106 by an initial distance. In the tuning network 1002, the antenna is represented electrically by an inductor (L1) that may have an inductance of 205 pH, a resistor (Rs1—antenna series resistance) that may have a resistance of 20.1 Ohms, and a capacitor (Cp1—antenna parasitic capacitance) that may have a capacitance of 56 pF. A series tuning capacitor (C1—located in the tool electronics) that may have a capacitance of 7.9 nF may be used to tune the antenna to the desired frequency of 125 kHz. The tuning network 1002 also may include a connection to a transmitter electronics module or another AC power amplifier/source.

In FIG. 10, a tuning network 1004 may be configured to retune a transmitter antenna with 20% higher inductance on the sub 102 for a 125 kHz signal, where the tuning network 1004 may be controlled by a microcontroller and switches (as similarly described with reference to FIG. 5). The tuning network 1004 may include a tuning capacitor (C2—located in the tool electronics) that may have a value of 7.9 nF, and a tuning adjustment capacitor (C6—located in the tuning module of the deep extension sub) that may have a value of 40 nF. The tuning network 1004 also may include the antenna, which is represented electrically by an inductor (L2) that may have a value of 246 μH, a resistor (R2—antenna series resistance) that may have a value of 16.08 Ohms, and a capacitor (Cp2—antenna parasitic capacitance) that may have a value of 56 μF. The tuning network 1004 also may include a connection to a transmitter electronics module or another AC power amplifier/source.

In FIG. 10, a tuning network 1006 may be configured to retune a transmitter antenna with 20% higher the sub 102 for a 125 kHz signal, where the tuning network 1004 may be a passive tuning network (such as the tuning network described with reference to FIGS. 7A and 7B). The tuning network may include the following components: the antenna represented electrically by a 246 μH inductor (L3), 16.08 Ohm resistor (Rs3—antenna series resistance), and 56 pF capacitor (Cp3—antenna parasitic capacitance); 7.9 nF tuning capacitor (C3—located in the tool electronics), 9.5 nF tuning adjustment capacitor (C7—for 250 Hz tuning); 250 Hz LC tank circuit consisting of 100 μH inductor (LA), 0.8 Ohm resistor (Rs4—inductor series resistance), and 4.05 nF capacitor (C4); 8.65 nF tuning adjustment capacitor (C8—for 125 kHz tuning); 125 kHz LC tank circuit consisting of 100 μH inductor (L5), 0.8 Ohm resister (Rs5—inductor series resistance), and 16.2 nF capacitor (C5); and 20 nF tuning adjustment capacitor (C9—for 62.5 kHz tuning). The tuning network 804 also may include a connection to a transmitter electronics module or another AC power amplifier/source.

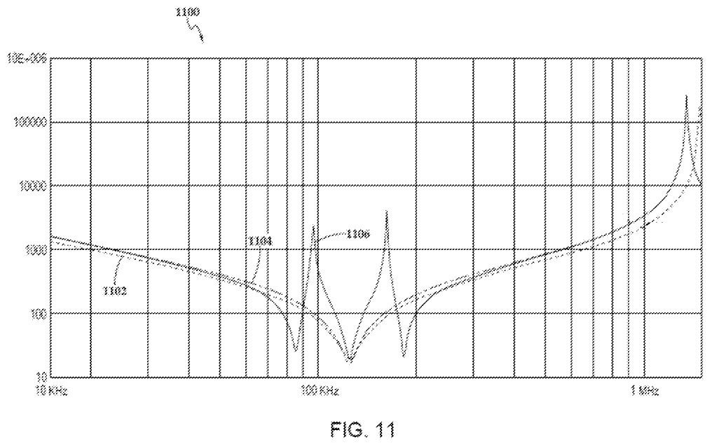

FIG. 11 is a graph showing tuning data from a simulation involving the tuning networks 1002, 1004, and 1006. In FIG. 11, a graph 1100 includes an XY plane on which an x-axis represents frequency increasing from left to right (beginning at 10 KHz and increasing logarithmically) and a y-axis represents representing signal impedance in Ohms increasing upward (beginning at 10 and increasing logarithmically). The line 1102 shows a relationship between frequency and signal impedance for the tuning network 1002. The line 1104 shows a relationship between frequency and signal impedance for the tuning network 1004. The line 1106 shows a relationship between frequency and signal impedance for the tuning network 1006, note the additional resonances/peaks in the frequency response due to the interactions of the LC tank circuits with the passive tuning network 1006. In FIG. 11, all 3 tuning networks show a minimum impedance where the antenna is tuned at 125 kHz.

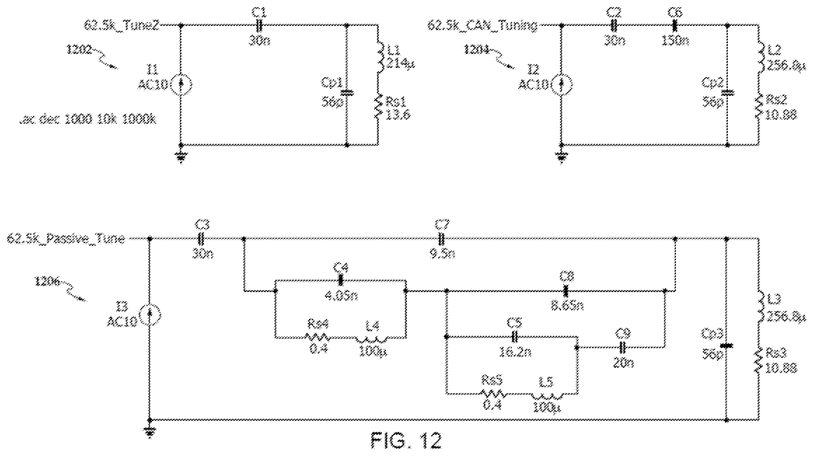

FIG. 12 is a diagrammatic/schematic illustration showing example tuning networks configured for use with a sub. In FIG. 12, a tuning network 1202 may be an initial configuration that tunes a transmitter antenna on the sub 102 for a 62.5 kHz signal, where the transmitter antenna is separated from a receiver antenna on the tool 106 by a distance. In the tuning network 1202, the antenna is represented by an inductor (L1) that may have an inductance of 214 μH, a resistor (Rs1—antenna series resistance) that may have a resistance of 13.6 Ohms, and a capacitor (Cp1—antenna parasitic capacitance) that may have a capacitance of 56 pF. A series tuning capacitor (C1—located in the tool electronics) that may have a capacitance of 30 nF is used to tune the antenna to the desired frequency of 62.5 kHz. The tuning network 1202 also may include a connection to a transmitter electronics module or another AC power amplifier/source.

In FIG. 12, a tuning network 1204 may be configured to retune a transmitter antenna with 20% higher inductance on the sub 102 for a 62.5 kHz signal, where the tuning network 1204 may be controlled by a microcontroller and switches (as similarly described with reference to FIG. 5). The tuning network 1204 may include a tuning capacitor (C2—located in the tool electronics) that may have a value of 30 nF, and a tuning adjustment capacitor (C6—located in the tuning module of the deep extension sub) that may have a value of 150 nF. The tuning network 1204 also may include the antenna, which is represented electrically by an inductor (L2) that may have a value of 256.8 μH, a resistor (R2—antenna series resistance) that may have a value of 10.88 Ohms, and a capacitor (Cp2—antenna parasitic capacitance) that may have a value of 56 pF. The tuning network 1204 also may include a connection to a transmitter electronics module or another AC power amplifier/source.

In FIG. 12, a tuning network 1206 may be configured to retune a transmitter antenna with 20% higher inductance on the sub 102 for a 62.5 kHz signal, where the tuning network 1204 may be a passive tuning network (such as the tuning network described with reference to FIGS. 7A and 7B). The tuning network may include the following components: the antenna represented electrically by a 256.8 μH inductor (L3), 10.88 Ohm resistor (Rs3—antenna series resistance) and a 56 pH capacitor (Cp3—antenna parasitic capacitance); 30 nF capacitor (C3—located in the tool electronics); 9.5 nF tuning adjustment capacitor (C7—for 250 KHz tuning); 250 kHz LC tank circuit including a 100 μH inductor (L4), 0.4 Ohms resistor (Rs4—inductor series resistance), and 4.05 nF capacitor (C4); 8.65 nF tuning adjustment capacitor (C8—for 125 kHz tuning); 125 kHz LC tank circuit including a 100 μH inductor (L5), 0.4 ohm resister (Rs5—inductor series resistance), and 16.2 nF capacitor (C5); and 20 nF tuning adjustment capacitor (C9—for 62.5 kHz tuning). The tuning network 804 also may include a connection to a transmitter electronics module or another AC power amplifier/source.

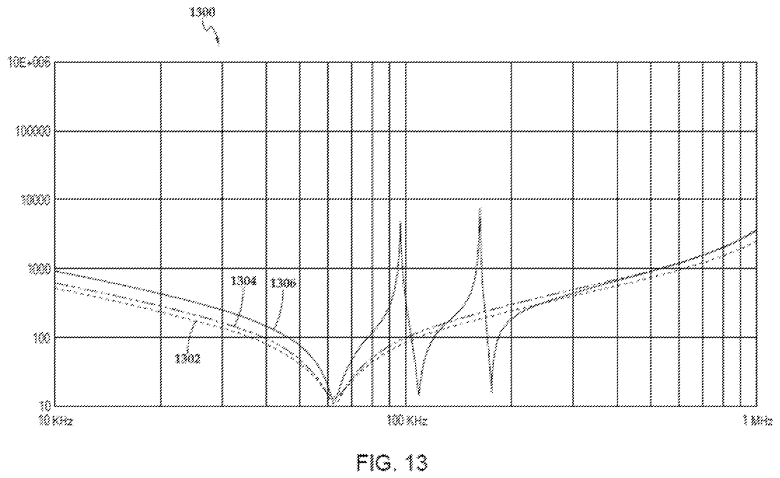

FIG. 13 is a graph showing tuning data from a simulation involving the tuning networks 1202, 1204, and 1206. In FIG. 13, a graph 1300 includes an XY plane on which an x-axis represents frequency increasing from left to right (beginning at 10 KHz) and a y-axis represents representing signal impedance increasing upward (beginning at 10 and growing exponentially). The line 1302 shows a relationship between frequency and signal impedance for the tuning network 1202. The line 1304 shows a relationship between frequency and signal impedance for the tuning network 1204. The line 1306 shows a relationship between frequency and signal impedance for the tuning network 1206, note the additional resonances/peaks in the frequency response due to the interactions of the LC tank circuits with the passive tuning network 1206. In FIG. 13, all 3 tuning networks show a minimum impedance where the antenna is tuned at 62.5 kHz.

Some implementations described here also may be used to retune new or existing deep expansion subs for higher operating frequencies that would be needed in high resistivity applications (as have been observed in certain parts of the Kingdom of Saudi Arabia). Referring back to Equation 1, increasing the tuning/operating frequency may require reducing the capacitance by the square of the increase in frequency. For example, increasing the frequency by 2 requires reducing the capacitance by 4 (2²), and increasing the frequency by 4 requires reducing the capacitance by 16 (4²) for the same antenna inductance (L). So even if the size, or inductance (L), and/or turns of the deep transmitter antennas have to be reduced to accommodate the higher frequencies (due to the self-resonance of the antenna, caused by the parasitic capacitance Cp), the tuning capacitance may still most likely need a significant reduction to be properly tuned for the higher operating frequencies, which can be achieved using the various implementations previously described.

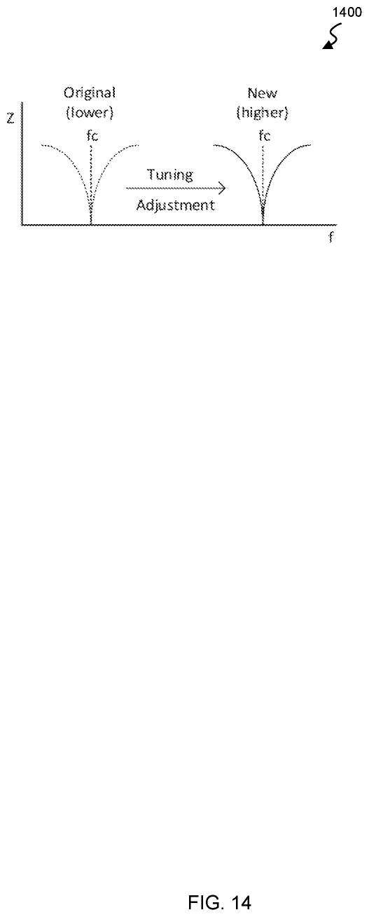

FIG. 14 is a graph showing how tuning adjustments may be used to achieve higher frequencies. In FIG. 14, the graph 1400 shows how the implementations described herein can be used to adjust the tuning of transmitter antennas to achieve higher operating frequencies for high resistivity applications using new or existing deep expansion subs without any hardware modifications to existing tools. This also allows them to be usable with the existing deep transmitter subs.

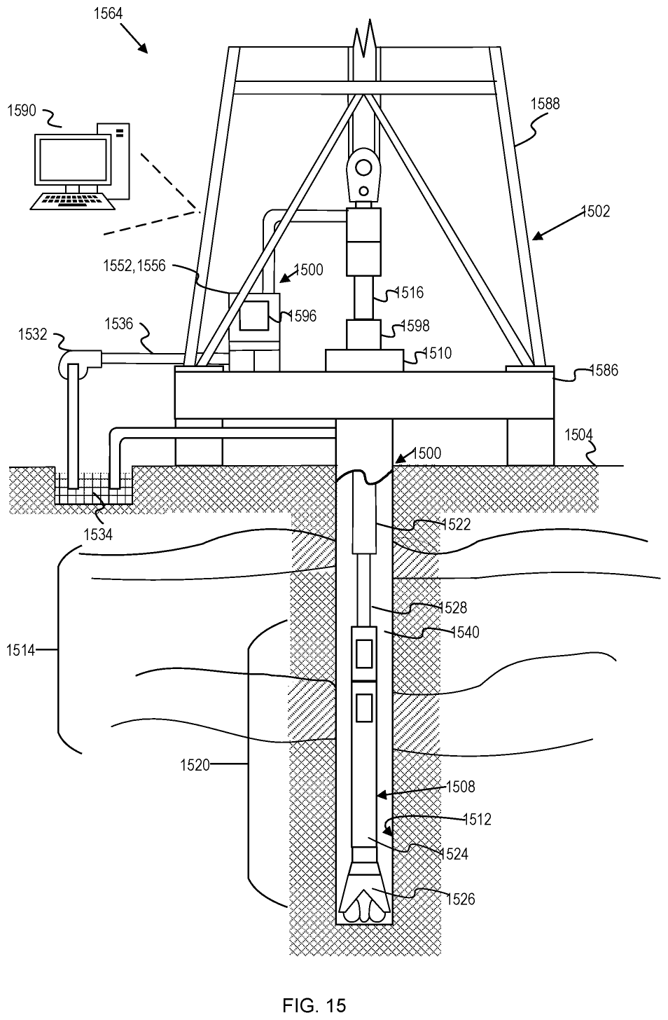

FIG. 15 is a schematic diagram of an example drilling rig system. In FIG. 15, a system 1564 may form a portion of a drilling rig 1502 located at the surface 1504 of a well 1506. Drilling of oil and gas wells may be carried out using a string of drill pipes connected together so as to form a drilling string 1508 that is lowered through a rotary table 1510 into a wellbore or borehole 1512. Here, a drilling platform 1586 is equipped with a derrick 1588 that supports a hoist. A geological data system 1590 can be communicatively coupled to any measurements devices attached to the system 1564 and can achieve parallelism in simulations as described above.

The drilling rig 1502 may thus provide support for the drill string 1508. The drill string 1508 may operate to penetrate the rotary table 1510 for drilling the borehole 1512 through subsurface formations 1514. The drill string 1508 may include a Kelly 1516, drill pipe 1518, and a bottom hole assembly 1520, perhaps located at the lower portion of the drill pipe 1518.

The bottom hole assembly 1520 may include drill collars 1522, a down hole tool 1524, and a drill bit 1526. The drill bit 1526 may operate to create a borehole 1512 by penetrating the surface 1504 and subsurface formations 1514. The down hole tool 1524 may comprise any of a number of different types of tools including MWD tools, LWD tools, and others. In some implementations, the bottom hole assembly 1520 may include a resistivity tool 106 and sub 102, where the sub 102 may include any of the component arrangements described herein.

During drilling operations, the drill string 1508 (perhaps including the Kelly 1516, the drill pipe 1518, and the bottom hole assembly 1520) may be rotated by the rotary table 1510. In addition to, or alternatively, the bottom hole assembly 1520 may also be rotated by a motor (e.g., a mud motor) that is located down hole. The drill collars 1522 may be used to add weight to the drill bit 1526. The drill collars 1522 may also operate to stiffen the bottom hole assembly 1520, allowing the bottom hole assembly 1520 to transfer the added weight to the drill bit 1526, and in turn, to assist the drill bit 1526 in penetrating the surface 1504 and subsurface formations 1514.

During drilling operations, a mud pump 1532 may pump drilling fluid (sometimes known by those of ordinary skill in the art as “drilling mud”) from a mud pit 1534 through a hose 1536 into the drill pipe 1518 and down to the drill bit 1526. The drilling fluid can flow out from the drill bit 1526 and be returned to the surface 1504 through an annular area 1540 between the drill pipe 1518 and the sides of the borehole 1512. The drilling fluid may then be returned to the mud pit 1534, where such fluid is filtered. In some embodiments, the drilling fluid can be used to cool the drill bit 1526, as well as to provide lubrication for the drill bit 1526 during drilling operations. Additionally, the drilling fluid may be used to remove subsurface formation 1514 cuttings created by operating the drill bit 1526. It is the images of these cuttings that many embodiments operate to acquire and process.

### General Comments

FIGS. 1-15 and the operations described herein are examples meant to aid in understanding example implementations and should not be used to limit the potential implementations or limit the scope of the claims. Some implementations may perform additional operations, fewer operations, operations in parallel or in a different order, and some operations differently. Although the description of some implementations refers to a receiver antenna or a transmitter antenna, other naming conventions are contemplated. For example, one or ordinary skill in the art with the benefit of this disclosure may refer to the transmitter antenna as a first antenna and a receiver antenna as a second antenna, or vice versa.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the Figures and indicate relative positions corresponding to the orientation of the Figure on a properly oriented page and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### More Example Implementations

Some implementations may include the following clauses.

Clause 1: A subassembly configured for attachment to a tubular in a borehole, the subassembly comprising: a tuning module configured to tune a first antenna to a first frequency based on a design requirement of the first antenna or a desired distance between the first antenna and a second antenna; and the first antenna configured to transmit or receive a signal at the first frequency to or from the second antenna.

Clause 2: The subassembly of clause 1, wherein the first antenna is a transmitter antenna, and the second antenna is a receiver antenna, or the first antenna is a receiver antenna and the second antenna is a transmitter antenna.

Clause 3: The subassembly of any one or more of clauses 1-2, wherein where the first antenna and the second antenna are located in different BHA sections with two different collars, wherein the first antenna collar does not have any electronics or minimum electronics, and the second antenna collar has the electronics to send control and communication signals among antennas.

Clause 4: The subassembly of any one or more of clauses 1-3, wherein the tuning module is configured to passively tune the first antenna to two or more frequencies via two or more signal paths, the tuning module including: a first signal path configured to tune the first antenna to the first frequency, the first signal path including a first capacitor; and a second signal path configured to tune the first antenna to a second frequency, the second signal path including a second capacitor and a first inductor-capacitor (LC) resonant circuit.

Clause 5: The subassembly of any one or more of clauses 1-4, wherein the tuning module is configured to tune the first antenna via series tuning.

Clause 6: The subassembly of any one or more of clauses 1-5, wherein the tuning module is configured to tune the first antenna via parallel tuning.

Clause 7: The subassembly of any one or more of clauses 1-6, wherein the tuning module includes a microcontroller configured to actively select a first signal path of a plurality of signal paths to the first antenna, wherein the first signal path is configured to tune the first antenna to the first frequency based on the design requirement of the first antenna or the desired distance between the first and the second antennas.

Clause 8: The subassembly of any one or more of clauses 1-7, wherein the microcontroller is further configured to actively select a second signal path of the plurality of signal paths, wherein the second signal path is configured to tune the first antenna to a second frequency based on the design requirement of the first antenna or the desired distance between the first and second antennas.

Clause 9: The subassembly of any one or more of clauses 1-8, wherein the first signal path and the second signal path each include a capacitor, and wherein the capacitors are connected in parallel to the first antenna.

Clause 10: The subassembly of any one or more of clauses 1-9, wherein the first signal path and the second signal path each include a respective capacitor, and wherein the respective capacitors are connected in series to the first antenna.

Clause 11: The subassembly of any one or more of clauses 1-10, wherein the microcontroller is connected to a communication bus that is also connected to one or more components disposed on the tubular.

Clause 12: A subassembly configured for attachment to a tubular in a borehole, the subassembly comprising: a tuning module configured to tune a plurality of antennas on the subassembly to different respective frequencies, wherein each respective frequency is different than any initial frequency to which each of the plurality of antennas was tuned; and the plurality of antennas each configured to transmit or receive signals at the respective frequency.

Clause 13: The subassembly of clause 12, wherein the tuning module includes a first signal path of a plurality of signal paths to a first antenna of the plurality of antennas, the first signal path including a first capacitor configured to passively retune the first antenna to a first new frequency.

Clause 14: The subassembly of any one or more of clauses 12-13, wherein the tuning module further includes: a second signal path of the plurality of signal paths including a second capacitor and a first inductor-capacitor (LC) resonant circuit, the second signal path configured to passively retune the first antenna to a second new frequency.

Clause 15: The subassembly of any one or more of clauses 12-14, wherein the first capacitor is connected in parallel with the second capacitor and the first inductor-capacitor resonant circuit, and wherein the second capacitor is connected in parallel with a third capacitor and a second inductor-capacitor resonant circuit.

Clause 16: The subassembly of any one or more of clauses 12-15, wherein the tuning module includes a microcontroller configured to actively select a first signal path of a plurality of signal paths to a first antenna of the plurality antennas, wherein the first signal path is configured to retune the first antenna to a first new frequency.

Clause 17: The subassembly of any one or more of clauses 12-16, wherein the microcontroller is further configured to actively select a second signal path of a plurality of signal paths, wherein the second signal path is configured to retune the first antenna to a second new frequency.

Clause 18: A method for retuning a first antenna of a plurality of antennas mounted on a subassembly configured to couple with a downhole tool, the method comprising: determining a design requirement of one or more of the plurality of antennas or a desired distance in between the first antenna and a second antenna mounted on the downhole tool; and adding a tuning module to the subassembly, the tuning module configured to tune the first antenna to a frequency based on the design requirements of the one or more of the plurality of antennas or a desired distance in between the first antenna and the second antenna.

Clause 19: The method of clause 18, the tuning module including: a microcontroller connected to a plurality of switches, each switch connected to a respective signal path configured to tune the first antenna to the frequency.

Clause 20: The method of any one or more of clauses 18-19, wherein the tuning module includes a tuning network configured to passively tune the first antenna to the frequency based on the design requirement of one or more of the plurality of antennas or the desired distance in between the first antenna and the second antenna.

What is claimed is:

1. A subassembly configured for attachment to a tubular in a borehole, the subassembly comprising:
a tuning module configured to tune a first antenna to a first frequency based on a design requirement of the first antenna or a desired distance between the first antenna and a second antenna; and
the first antenna configured to transmit or receive a signal at the first frequency to or from the second antenna.

2. The subassembly of claim 1, wherein the first antenna is a transmitter antenna, and the second antenna is a receiver antenna, or the first antenna is a receiver antenna, and the second antenna is a transmitter antenna.

3. The subassembly of claim 1, where the first antenna and the second antenna are located in different bottom hole assembly sections with two different collars,
wherein the first antenna collar does not have any electronics or minimum electronics, and
the second antenna collar has the electronics to send control and communication signals among antennas.

4. The subassembly of claim 1, wherein the tuning module is configured to passively tune the first antenna to two or more frequencies via two or more signal paths, the tuning module including:
a first signal path configured to tune the first antenna to the first frequency, the first signal path including a first capacitor; and
a second signal path configured to tune the first antenna to a second frequency, the second signal path including a second capacitor and a first inductor-capacitor (LC) resonant circuit.

5. The subassembly of claim 4, wherein the tuning module is configured to tune the first antenna via series tuning.

6. The subassembly of claim 4, wherein the tuning module is configured to tune the first antenna via parallel tuning.

7. The subassembly of claim 1, wherein the tuning module includes a microcontroller configured to actively select a first signal path of a plurality of signal paths to the first antenna, wherein the first signal path is configured to tune the first antenna to the first frequency based on the design requirement of the first antenna or the desired distance between the first and the second antennas.

8. The subassembly of claim 7, wherein the microcontroller is further configured to
actively select a second signal path of the plurality of signal paths, wherein the second signal path is configured to tune the first antenna to a second frequency based on the design requirement of the first antenna or the desired distance between the first and second antennas.

9. The subassembly of claim 8, wherein the first signal path and the second signal path each include a capacitor, and wherein the capacitors are connected in parallel to the first antenna.

10. The subassembly of claim 9, wherein the first signal path and the second signal path each include a respective capacitor, and wherein the respective capacitors are connected in series to the first antenna.

11. The subassembly of claim 7, wherein the microcontroller is connected to a communication bus that is also connected to one or more components disposed on the tubular.

12. A subassembly configured for attachment to a tubular in a borehole, the subassembly comprising:
a tuning module configured to tune a plurality of antennas on the subassembly to different respective frequencies, wherein each respective frequency is different than any initial frequency to which each of the plurality of antennas was tuned; and
the plurality of antennas each configured to transmit or receive signals at the respective frequency.

13. The subassembly of claim 12, wherein the tuning module includes a first signal path of a plurality of signal paths to a first antenna of the plurality of antennas, the first signal path including a first capacitor configured to passively retune the first antenna to a first new frequency.

14. The subassembly of claim 13, wherein the tuning module further includes:
a second signal path of the plurality of signal paths including a second capacitor and a first inductor-capacitor (LC) resonant circuit, the second signal path configured to passively retune the first antenna of the plurality of antennas to a second new frequency.

15. The subassembly of claim 14, wherein the first capacitor is connected in parallel with the second capacitor and the first inductor-capacitor resonant circuit.

16. The subassembly of claim 12, wherein the tuning module includes a microcontroller configured to actively select a first signal path of a plurality of signal paths to a first antenna of the plurality of antennas, wherein the first signal path is configured to retune the first antenna to a first new frequency.

17. The subassembly of claim 16, wherein the microcontroller is further configured to
actively select a second signal path of a plurality of signal paths, wherein the second signal path is configured to retune the first antenna to a second new frequency.

18. A method for tuning a first antenna of a plurality of antennas mounted on a subassembly configured to couple with a downhole tool, the method comprising:
determining a design requirement of one or more of the plurality of antennas or a desired distance in between the first antenna and a second antenna mounted on the downhole tool; and
adding a tuning module to the subassembly, the tuning module configured to tune the first antenna to a frequency based on the design requirements of the one or more of the plurality of antennas or a desired distance in between the first antenna and the second antenna.

19. The method of claim 18, wherein the tuning module including:
a microcontroller connected to a plurality of switches, each switch connected to a respective signal path configured to tune the first antenna to the frequency.

20. The method of claim 18, wherein the tuning module includes a tuning network configured to passively tune the first antenna to the frequency based on the design requirement of one or more of the plurality of antennas or the desired distance in between the first antenna and the second antenna.
